(19) United States
(12) Patent Application Publication
(10) Pub. No.: US 2022/0403134 A1
(43) Pub. Date: Dec. 22, 2022

(54) RESIN POWDER FOR THREE-DIMENSIONAL ADDITIVE MANUFACTURING, METHOD FOR PRODUCING RESIN POWDER FOR THREE-DIMENSIONAL ADDITIVE MANUFACTURING, THREE-DIMENSIONAL ADDITIVE MANUFACTURING PRODUCT, AND METHOD FOR PRODUCING THREE-DIMENSIONAL ADDITIVE MANUFACTURING PRODUCT

(71) Applicant: Konica Minolta, Inc., Tokyo (JP)

(72) Inventors: Masaharu SHIRAISHI, Yokohama-shi, Kanagawa (JP); Kenji GOTO, Hachioji-shi, Tokyo (JP); Takeshi KOJIMA, Hachioji-shi, Tokyo (JP)

(21) Appl. No.: 17/755,994

(22) PCT Filed: Oct. 28, 2020
(86) PCT No.: PCT/JP2020/040347

§ 371 Date: May 13, 2022

(30) Foreign Application Priority Data
Dec. 4, 2019 (JP) 2019-219380

(51) Int. Cl. C08K 3/36; C08J 3/12; B33Y 10/00; B33Y 40/10; B33Y 70/00; B29C 64/153; B29C 64/314

(52) U.S. Cl. CPC C08K 3/36; C08J 3/12; B33Y 10/00; B33Y 40/10; B33Y 70/00; B29C 64/153; B29C 64/314; C08J 2323/12; B29K 2023/12

(57) ABSTRACT

A resin powder for three-dimensional laminated modeling contains an aggregate of resin particles. A volume average particle size MV of the resin particles is in the range of 1 to 200 μm. A value of a ratio (MV/MN) of the volume average particle size MV and a number average particle size MN of the resin particles is 2.5 or more. A static bulk density is 0.30 g/cm3 or more. The resin particles contain a crystalline thermoplastic resin.

### TECHNICAL FIELD

The present invention relates to a resin powder for three-dimensional laminated modeling, a method for producing a resin powder for three-dimensional laminated modeling, a three-dimensional laminated model, and a method for producing a three-dimensional laminated model. In particular, the present invention relates to a resin powder for three-dimensional laminated modeling in which resin particles having different particle sizes are arranged at a high packing density and the tensile strength of the three-dimensional laminated model is good, and a method for producing the same resin powder. The present invention also relates to a three-dimensional laminated model formed using this resin powder, and a method for producing the same three-dimensional laminated model.

### BACKGROUND

In recent years, various methods have been developed that may relatively easily produce a three-dimensional laminated model having a complicated shape. As one of the methods for producing a three-dimensional laminated model, a “powder bed fusion method (PBF method” is known. The powder bed fusion method is characterized by high modeling accuracy and high adhesive strength between laminated layers. Therefore, the powder bed fusion method may be applied not only to the production of a prototype for confirming the shape or property of the final product, but also to the production of the final product.

In the powder bed fusion method, a powder material containing particles of a resin material or a metal material is flatly spread to form a thin film, and a laser is irradiated to a desired position on the thin film to selectively sinter or melt the particles contained in the powder material (hereinafter, the bonding of particles by sintering or melting is also simply referred to as “melt-bonding”) to subdivide the three-dimensional laminated model in the thickness direction (hereinafter, simply “modeling object layer”). The powder material is further spread on the layer thus formed, and the particles contained in the powder material are selectively melt-bonded by irradiating with a laser to form the next modeling object layer. By repeating this procedure and stacking the modeling object layers, a three-dimensional laminated modeling object having a desired shape is produced.

In recent years, it has been possible to improve the fluidity by producing monodisperse particles having the same particle size as the resin powder, but the modeling density is inferior, and the three-dimensional laminated model formed using the resin powder has a problem of being inferior in strength.

To solve the above problem, a method is disclosed in which two types of columnar particles with different particle sizes are used as the three-dimensional modeling powder, and by setting the value of the ratio of the volume average particle size/the number average particle size of the prismatic particles having a large particle size to a specific range or less, the columnar particles may be packed more densely and the strength of the obtained three-dimensional structure may be improved (refer to, for example, Patent Document 1).

However, in the method described in Patent Document 1, the particles to be applied have a columnar shape, and even if columnar particles having different particle sizes are mixed, the static bulk density is low and it is difficult to obtain a close-packed state. As a result, the strength of the obtained three-dimensional laminated model is insufficient. Further, as a method for producing particles, since two types of columnar particles are produced in different processes, there is a problem in productivity.

### PRIOR ART DOCUMENTS

### Patent Documents

Patent Document 1: JP-A 2019-84815

### SUMMARY OF THE INVENTION

### Problems to be Solved by the Invention

The present invention has been made in view of the above problems and situations. The solution to the problem is to provide a resin powder for three-dimensional laminated model excellent in tensile strength by arranging spherical resin particles having different particle sizes at a high packing density, a method for producing the resin powder for three-dimensional laminated modeling, a three-dimensional laminated model by using the resin powder, and a method for producing the three-dimensional laminated model.

### Means to Solve the Problems

The present inventor has found the following in the process of examining the cause of the above problem in order to solve the above problem. The found resin powder for three-dimensional laminated modeling is composed of an aggregate of resin particles, the volume average particle size of the resin particles is set to a specific range, and the ratio of the volume average particle size MV of the resin particles to the number average particle size MN (MV/MN)) and a static bulk density are specified under specific conditions, and crystalline thermoplastic resin is applied as resin particles. As a result, it is possible to provide a resin powder for three-dimensional laminated modeling capable of obtaining a three-dimensional laminated model having excellent tensile strength. Thus, the present invention has been found.

That is, the above-mentioned problem according to the present invention is solved by the following means.

1. A resin powder for three-dimensional laminated modeling comprising an aggregate of resin particles, wherein a volume average particle size MV of the resin particles is in the range of 1 to 200 μm; a value of a ratio (MV/MN) of the volume average particle size MV and a number average particle size MN of the resin particles is 2.5 or more; a static bulk density is 0.30 g/cm³ or more; and the resin particles contain a crystalline thermoplastic resin.
2. The resin powder for three-dimensional laminated modeling according to the item 1, containing small-sized resin particles having an average particle size in the range of 0.15 to 0.41 times the number average particle size MN of the resin particles in an amount of the same or more with respect to a particle number of the resin particles having the number average particle size MN.
3. The resin powder for three-dimensional laminated modeling according to the item 1 or 2, wherein inorganic oxide is present on a surface of the resin particles in the range of 0.01 to 0.3 mass % with respect to the resin particles.
4. A method for producing the resin powder for three-dimensional laminated modeling according to any one of the items 1 to 3, comprising the steps of:

crushing a resin into resin particles by a mechanical crushing method; and

subjecting the formed resin particles to a particle spheroidization treatment to form spheres.

5. A three-dimensional laminated model formed of a sintered body or a melt body of the resin powder for three-dimensional laminated modeling according to any one of the items 1 to 3.
6. A method for producing a three-dimensional laminated model using a resin powder for three-dimensional laminated modeling, comprising the step of:

producing a three-dimensional laminated model by a powder bet fusion method using the resin powder for three-dimensional laminated modeling according to any one of the items 1 to 3.

7. The method for producing a three-dimensional laminated model according to the item 6, comprising the steps of:

(1) forming a thin layer of the resin powder for three-dimensional laminated modeling; and

(2) selectively irradiating the formed thin layer with laser light to form a modeling object layer in which the resin particles contained in the resin powder for a three-dimensional laminated modeling are sintered or melt-bonded,

(3) laminating the modeling object layer by repeating the step (1) of forming the thin layer and the step (2) of forming the modeling object layer a plurality of times in this order.

### Effects of the Invention

By the above means of the present invention, it is possible to provide a resin powder for three-dimensional laminated modeling producing a three-dimensional laminated model having good tensile strength, and a method for producing the resin powder by arranging spherical resin particles having different particle sizes at a high packing density. It is also possible to provide a three-dimensional laminated model that has been produced using the resin powder and a method for producing the three-dimensional laminated model.

Although the mechanism of expression or mechanism of action of the effects of the present invention has not been clarified, it is inferred as follows.

In the resin powder for three-dimensional laminated modeling of the present invention, as the resin particles used for producing the three-dimensional laminated model, the volume average particle size MV is set in the range of 1 to 200 μm, and the value of the ratio (MV/MN) of the volume average particle size MV and the number average particle size MN of the resin particles is set to be 2.5 or more, the static bulk density is set to be 0.30 g/cm³ or more, and the resin particles contain a crystalline thermoplastic resin. As a result, the resin particles are packed more densely when the three-dimensional laminated model is formed, the volume of the void portion formed between the resin particles is minimized, the adhesion between the resin particles is dramatically improved, and the strength is improved. Thus, it was possible to obtain an excellent three-dimensional laminated structure.

FIG. 1A to FIG. 1C each are a schematic view showing an example of a typical configuration of a three-dimensional laminated model formed by using resin particles having each particle size.

The three-dimensional laminated model 1 shown in FIG. 1A is a conventional three-dimensional laminated model composed of monodisperse resin particles 2 alone. Although it is arranged in a close-packed state and the fluidity may be improved, since a wide void portion 3 is present between the resin particles 2, the adhesion between the particles is low. Since the static bulk density is low, it is not possible to obtain sufficient strength of the three-dimensional laminated model 1.

The three-dimensional laminated model 1 shown in FIG. 1B is a conventional three-dimensional laminated model formed by mixing a resin particle 2 having a large particle size and a resin particle 4 having a medium particle size. Since the void portion 3 formed between the resin particles 2 and the resin particles 4 has a high ratio, the adhesion between the particles is low and the static bulk density is low, so that it is not possible to obtain the strength as the three-dimensional laminated model 1.

FIG. 1C shows the structure of the three-dimensional laminated model 1 of the present invention. It is characterized by that, as the resin powder, a multi-dispersion system having a wide particle size distribution in which the ratio (volume average particle size/number average particle size) (MV/MN) between the volume average particle size MV and the number average particle size MN being 2.5 or more, and having a static bulk density of 0.3 g/cm³ or more is used. As shown in FIG. 1C, the resin powder is prepared by allowing the same number or more of the small-sized resin particles 5 to be present with respect to the large particle size resin particles 2 (for example, the resin particles 5 have an average particle size in the range of 0.15 to 0.41 times the number average particle size MN of the resin particles 2). Thereby, the volume of the void portion 3 formed between the resin particles 2 having a large particle size and the resin particles 5 having a small particle size may be greatly suppressed. As a result, the static bulk density was high, the adhesion between the resin particles was dramatically improved, and the strength of the three-dimensional laminated model 1 was improved.

### BRIEF DESCRIPTION OF THE DRAWINGS

FIG. 1A is a schematic diagram showing an example of a conventional configuration of a three-dimensional laminated model formed of resin particles.

FIG. 1B is a schematic diagram showing another example of the conventional configuration of a three-dimensional laminated model formed of resin particles.

FIG. 1C is a schematic diagram showing an example of the configuration of the present invention of a three-dimensional laminated model formed of resin particles.

FIG. 2 is a side view schematically showing a configuration of a three-dimensional modeling apparatus according to an embodiment of the present invention.

FIG. 3 is a block diagram showing a main part of a control system of a three-dimensional modeling apparatus according to an embodiment of the present invention.

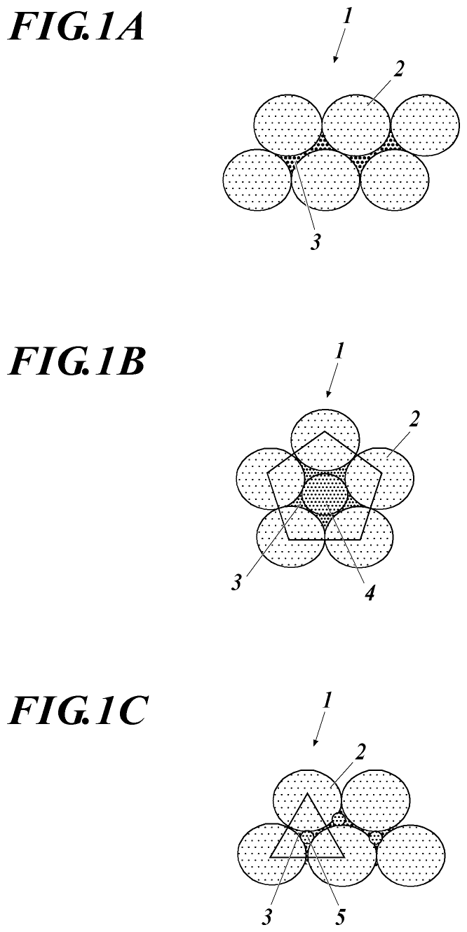

### EMBODIMENT OF CARRY OUT THE INVENTION

The resin powder for three-dimensional laminated modeling of the present invention is a resin powder for three-dimensional laminated modeling composed of an aggregate of resin particles. A volume average particle size MV of the resin particles is in the range of 1 to 200 μm, a value of a ratio (MV/MN) of the volume average particle size MV and a number average particle size MN of the resin particles is 2.5 or more, a static bulk density is 0.30 g/cm³ or more, and the resin particles contain a crystalline thermoplastic resin.

This feature is a technical feature common to or corresponding to each of the following embodiments.

As an embodiment of the present invention, from the viewpoint that the desired effect of the present invention may be more exhibited, it is preferable that small-sized resin particles having an average particle size in the range of 0.15 to 0.41 times the number average particle size MN of the resin particles exist in an amount of the same or more with respect to a particle number of the resin particles having the number average particle size MN. By arranging particles having an average particle size of 0.15 to 0.41 times the number average particle size MN between the particles having the number average particle size MN, the volume ratio of the void portion is reduced. As a result, the static bulk density is high, the adhesion between resin particles is improved, and the strength as a three-dimensional laminated model may be increased.

Further, in the present invention, the presence of an inorganic oxide on the surface of the resin particles in the range of 0.01 to 0.3 mass % with respect to the resin particles causes the inorganic oxide to function as a flow agent. The fluidity of the resin powder for three-dimensional laminated modeling may be further improved. It is preferable in that it may facilitate the handling of the resin powder for three-dimensional laminated modeling at the time of producing the three-dimensional laminated model.

Further, the method for producing the resin powder for three-dimensional laminated modeling of the present invention includes steps of: crushing a resin by a mechanical crushing method to form resin particles; and subjecting the formed resin particles to a particle spheroidization treatment to form spheres. It is characterized in that resin powder for three-dimensional laminated modeling is produced through these processes.

The three-dimensional laminated model of the present invention is characterized by being a sintered body or a melt body of the resin powder for three-dimensional laminated modeling of the present invention. As a result, it is possible to obtain a three-dimensional laminated model using a crystalline thermoplastic resin having good tensile strength and excellent breaking elongation.

The method for producing a three-dimensional laminated model of the present invention is characterized in that the resin powder for three-dimensional laminated modeling of the present invention is used to produce a three-dimensional laminated model by a powder bed fusion method.

In the method for producing a three-dimensional laminated model, it is preferable to contain the following steps: the step (1) of forming a thin layer of the resin powder for three-dimensional laminated modeling; the step (2) of selectively irradiating the formed thin layer with a laser beam to form a modeling object layer in which the resin particles contained in the three-dimensional laminated modeling resin powder are sintered or melt-bonded; and the step (3) of laminating the modeling object layer by repeating the step (1) of forming the thin layer and the step (2) of forming the modeling object layer a plurality of times in this order. As a result, it is possible to obtain a three-dimensional laminated model using a crystalline thermoplastic resin, which has good tensile strength and excellent break elongation. In addition, it is possible to obtain a three-dimensional laminated model having high modeling accuracy and high adhesive strength between the laminated layers.

Hereinafter, the present invention, its constituent elements, and modes and embodiments for carrying out the present invention will be described. In addition, in this application, “to” is used in the meaning which includes the numerical values described before and after “to” as the lower limit value and the upper limit value.

### <<Resin Powder for Three-Dimensional Laminated Modeling>>

The resin powder for three-dimensional laminated modeling of the present invention (hereinafter, also simply referred to as a resin powder) has a volume average particle size MV of the resin particles in the range of 1 to 200 μm. A value of a ratio (MV/MN) of a volume average particle size MV and a number average particle size MN is 2.5 or more, a static bulk density is 0.30 g/cm³ or more, and the resin particles contain a crystalline thermoplastic resin. The resin particles referred to in the present invention refer to a group of all resin particles constituting the resin powder for three-dimensional laminated modeling. Further, the resin powder for three-dimensional laminated modeling of the present invention may contain resin particles of other types as long as the effects of the present invention are not impaired.

### [Crystalline Thermoplastic Resin]

The resin powder of the present invention is characterized in that the constituent resin particles contain a crystalline thermoplastic resin as a main component. The main component referred to in the present invention has a structure in which 60 mass % or more of the total mass of the resin is a crystalline thermoplastic resin, preferably 80 mass % or more is a crystalline thermoplastic resin, and more preferably 90 mass % or more is a crystalline thermoplastic resin. It is particularly preferable that all of the resin components are made of the crystalline thermoplastic resin.

The crystalline thermoplastic resin applicable to the present invention is not particularly limited and may be appropriately selected depending on the intended purpose. Examples thereof include polymers such as polyolefin, polyamide, polyester, polyarylketone, polyphenylene sulfide, polyacetal, and fluororesin. These may be used alone or in combination of two or more.

Examples of the polyolefin include polyethylene and polypropylene. These may be used alone or in combination of two or more. These may also be obtained as commercial products. Examples of polyethylene include Novatic HDHJ580N manufactured by Japan Polyethylene Corporation, and examples of polypropylene include Noblen FLX80E4 manufactured by Sumitomo Chemical Corporation.

Examples of the polyamide include Polyamide 410 (PA410), Polyamide 6 (PA6), Polyamide 66 (PA66, melting point: 265° C.), Polyamide 610 (PA610), Polyamide 612 (PA612), Polyamide 11 (PA11), Polyamide 12 (PA12); Semi-aromatic Polyamide 4T (PA4T), Polyamide MXD6 (PAMXD6), Polyamide 6T (PA6T), Polyamide 9T (PA9T, melting point: 300° C.), and Polyamide 10T (PA10T). These may be used alone or in combination of two or more. Among these, PA9T is also called polynonamethylene terephthalamide, and it is compose of a diamine having carbon atoms of 9 and a terephthalic acid monomer. It is called semi-aromatic because the carboxylic acid side thereof is generally aromatic. Further, the polyamide of the present invention also includes what is called aramid, which is composed of p-phenylenediamine and a terephthalic acid monomer as a total aromatic whose diamine side is also aromatic.

Examples of the polyester include polyethylene terephthalate (PET, melting point: 260° C.), polybutylene terephthalate (PBT, melting point: 218° C.), and polylactic acid (PLA). In order to impart heat resistance, polyesters partially having aromatic compounds containing terephthalic acid or isophthalic acid may also be suitably used in the present invention. As a commercially available product, for example, as the polybutylene terephthalate, Novaduran 5010R3 manufactured by Mitsubishi Chemical Corporation may be mentioned.

Examples of the polyarylketone include polyetheretherketone (PEEK, melting point: 343° C.), polyetherketone (PEK), polyetherketone ketone (PEKK), polyaryletherketone (PAEK), polyetheretherketone ketone. (PEEKK), and polyetherketone etherketoneketone (PEKEKK). In addition to the polyarylketone, any crystalline polymer may be used. Examples thereof include polyacetal, polyimide, and polyethersulphon. Those having two melting point peaks such as PA9T may also be used.

In contrast to the crystalline thermoplastic resin according to the present invention, as an amorphous thermoplastic resin which is a resin outside the specification of the present invention is mentioned as follows. Examples thereof include PVC (polyvinyl chloride), PS (polystyrene), PMMA (polymethylmethacrylate), ABS (acrylonitrile-butadiene-styrene), PC (polycarbonate), m-PPE (modified polyphenylene ether), and PES/PEUS (polyether sulfone).

### [Volume Average Particle Size]

The present invention is characterized in that the volume average particle size MV of the resin particles is in the range of 1 to 200 μm, preferably in the range of 10 to 150 μm, and more preferably in the range of 20 to 100 μm.

### (Measurement of Volume Average Particle Size MV of Resin Particles)

The volume average particle size MV of the crystalline thermoplastic resin particles according to the present invention was determined by using a particle size distribution measuring device (Microtrac MT3300EXII, manufactured by MicrotracBEL Corp.) and using the particle refractive index of the resin particles. A solvent was not used, and measurement was done by the dry (atmospheric) method. The refractive index of the particles was set to 1.5. As a measurement procedure, 0.2 g of a surfactant (EMAL E-27C, manufactured by Kao Corporation) and 30 mL of water were added to 0.1 g of resin particles, and ultrasonic dispersion treatment was performed according to a 10-minute conventional method.

### (Preparation Method)

The volume average particle size MV of the crystalline thermoplastic resin particles according to the present invention is obtained as follows. For example, the crystalline thermoplastic resin particles are crushed by a crushing method such as a mechanical crushing method, and then the conditions for carrying out the particle spheroidization treatment are appropriately selected by using the particle spheroidizing means of each method. By this, the desired volume average particle size MV may be obtained.

### [Ratio of Volume Average Particle Size MV to Number Average Particle Size MN (MV/MN)]

In the resin particles according to the present invention, the value of the ratio (MV/MN) of the volume average particle size MV of the resin particles described above and the number average particle size MN obtained by measuring by the following method is characterized by being 2.5 or more. It is preferably in the range of 2.5 to 4.0, more preferably in the range of 2.6 to 3.5, and particularly preferably in the range of 2.7 to 3.0.

In the present invention, the number average particle size MN of the resin particles is not particularly limited as long as it satisfies the conditions specified above. It is preferably in the range of 5 to 100 μm, and is more preferably in the range of 10 to 75 μm. It is particularly preferable that it is in the range of 20 to 50 μm.

### (Measurement of Number Average Particle Size MN of Resin Particles)

The number average particle size MN of the crystalline thermoplastic resin particles according to the present invention was determined by using a particle size distribution measuring device (Microtrac MT3300EXII, manufactured by MicrotracBEL Corp.) and using the particle refractive index of the resin particles. A solvent was not used, and measurement was done by the dry (atmospheric) method. The refractive index of the particles was set to 1.5. As a measurement procedure, 0.2 g of a surfactant (EMAL E-27C, manufactured by Kao Corporation) and 30 mL of water were added to 0.1 g of resin particles, and ultrasonic dispersion treatment was performed according to a 10-minute conventional method.

### (Preparation Method)

The number average particle size MN of the crystalline thermoplastic resin particles according to the present invention is also obtained as follows. For example, the crystalline thermoplastic resin particles are crushed by a crushing method such as a mechanical crushing method, and then the conditions for carrying out the particle spheroidization treatment are appropriately selected by using the particle spheroidizing means of each method. By this, the desired number average particle size MN may be obtained.

### [Static Bulk Density]

The resin powder of the present invention is characterized by having a static bulk density of 0.30 g/cm³ or more, preferably in the range of 0.30 to 0.42 g/cm³, and more preferably in the range of 0.35 to 0.40 g/cm³.

### (Measuring Method of Static Bulk Density)

The static bulk density of the resin powder according to the present invention may be determined according to the following method.

When using a cubic cup as a measuring container, a minimum amount of 25 cm³ of powder is used, and when using a cylindrical cup, a minimum amount of 35 cm³ powder is used. The resin powder is allowed to flow down through the measuring device until the excess powder overflows into the cup that serves as the receiver. Smoothly move the blade of the spatula that is in contact with the top surface of the cup vertically, and keep the spatula vertical to prevent consolidation and powder overflow from the cup, and carefully scrape off excess resin powder from the top surface of the cup.

Remove all the sample from the side of the cup and measure the mass (m) of the powder to a unit of 0.1%.

Next, the static bulk density (g/cm³) is calculated by the formula: m/V0 (V0 is the volume of the cup). Using three different measurement samples, the average value of the three measured values is obtained, and this is defined as the static bulk density (g/cm³) of the resin powder.

### (Preparation Method)

The static bulk density of the crystalline thermoplastic resin particles according to the present invention is also obtained as follows. For example, the crystalline thermoplastic resin particles are crushed by a crushing method such as a mechanical crushing method, and then the conditions for carrying out the particle spheroidization treatment are appropriately selected by using the particle spheroidizing means of each method. By this, the desired static bulk density may be obtained.

### [Number Average Particle Size Distribution]

In the present invention, a preferable embodiment is that the small-sized resin particles having an average particle size in the range of 0.15 to 0.41 times the number average particle size MN of the resin particles exist in an amount of the same or more with respect to a particle number of the particles having the number average particle size MN.

That is, when the number of particles having the number average particle size MN is M1, and the number of particles having an average particle size of 0.15 to 0.41 times the number average particle size Mn is M2, the value of the ratio represented by M1/M2 is preferably 0.5 or less.

As a result, small-sized resin particles having an average particle size of 0.15 to 0.41 times the number average particle size MN are arranged between the particles having the number average particle size MN. By filling the void portion, toughness may be increased while maintaining strength.

### [Other Constituent Materials of Resin Powder for Three-Dimensional Laminated Modeling]

In the resin powder for three-dimensional laminated modeling of the present invention, when forming a melt-bond and a thin layer by laser irradiation, which will be described later, other materials such as a laser absorber and a flow agent may be further contained in addition to the resin particles, within a range that does not significantly hinder the dense filling of the crystalline thermoplastic resin particles according to the present invention and does not significantly reduce the accuracy of the three-dimensional laminated model.

### (Laser Absorber)

From the viewpoint of more efficiently converting the light energy of the laser into heat energy, the resin powder for three-dimensional laminated modeling may further contain a laser absorber. The laser absorber may be any material that absorbs a laser having a wavelength to be used and generates heat. Examples of such laser absorbers include carbon powders, nylon resin powders, pigments and dyes. These laser absorbers may be used alone or in combination of two or more.

The amount of the laser absorber may be appropriately set within a range in which the copolymer particles may be easily melted and bonded. For example, the amount of the laser absorber is more than 0 mass % and less than 3 mass % with respect to the total mass of the resin powder for three-dimensional laminated modeling.

### (Flow Agent)

From the viewpoint of further improving the fluidity of the resin powder for the three-dimensional laminated modeling and facilitating the handling of the resin powder for the three-dimensional modeling at the time of producing the three-dimensional laminated model, the resin powder for the three-dimensional laminated modeling may further contain a flow agent.

The flow agent may be any material having a small coefficient of friction and self-lubricating property. Examples of such a flow agent include inorganic oxides such as silicon dioxide (silica particles) and boron nitride. These flow agents may be used alone or in combination of two or more. In the resin powder for three-dimensional laminated modeling, even if the fluidity is increased by the flow agent, the copolymer particles are less likely to be charged, and the copolymer particles may be further densely filled when forming a thin film.

The amount of the flow agent may be appropriately set within a range in which the fluidity of the resin powder for three-dimensional laminated modeling is further improved and the melt-bonding of the copolymer particles is sufficiently generated. From the viewpoint of not affecting the strength at the time of forming the three-dimensional laminated model, it is preferable that the inorganic oxide is present on the surface of the resin particles in the range of 0.01 to 0.3 mass % with respect to the total mass of the resin powder for three-dimensional laminated modeling. It is preferable in that fluidity may be ensured and excellent strength (tensile elastic modulus) may be obtained.

### <<Production Method of Resin Powder for Three-Dimensional Laminated Modeling>>

In the method for producing a resin powder for three-dimensional laminated modeling of the present invention, the method contains the steps of: after synthesizing a crystalline thermoplastic resin according to a conventional method, crushing the crystalline thermoplastic resin by a mechanical crushing method to form particles; and subjecting the above-mentioned particles to a particle spheroidization treatment to form sphere particles. Thus, the resin powder is produced. By such a treatment, it is possible to produce a resin powder for three-dimensional laminated modeling in which the volume average particle size of the crystalline thermoplastic resin particles is in the range of 1 to 200 μm.

### (Mechanical Crushing Method)

The mechanical crushing method according to the present invention is a method of mechanically crushing the produced crystalline thermoplastic resin particles to produce primary particles having a desired average particle size.

As an example of the mechanical crushing method applicable to the present invention, resin particles may be prepared according to the following method.

The crystalline thermoplastic resin particles may be frozen and then crushed, or may be crushed at room temperature. The mechanical crushing method may be performed by a known device for crushing a thermoplastic resin. Examples of such crushers include a hammer mill, a jet mill, a ball mill, an impeller mill, a cutter mill, a pin mill and a twin-screw crusher.

In the mechanical crushing method, the crystalline thermoplastic resin particles may be fused to each other due to the frictional heat generated from the crystalline thermoplastic resin particles during crushing, and particles having a desired particle size may not be obtained. Therefore, a method of cooling the crystalline thermoplastic resin particles with liquid nitrogen to make them embrittled and then crushing them is preferable.

According to the mechanical crushing method, by appropriately adjusting the amount of the solvent with respect to the crystalline thermoplastic resin particles, the crushing method, and the speed, the average particle size of the finally prepared crystalline thermoplastic resin particles may be adjusted in a desired range (volume average particle size of 1 to 200 μm). The particle size obtained by crushing is determined by the operating time of the apparatus, and it is preferably in the range of 5 to 45 hours.

Specifically, it is preferable to cool the crystalline thermoplastic resin particles with liquid nitrogen to about −150° C. and crush them with the above crushing device so that the volume average particle size is within the range of 1 to 200 μm.

### (Particle Spheroidization Treatment)

In the method for producing a resin powder for three-dimensional laminated modeling of the present invention, the resin is crushed into particles by a mechanical crushing method by the above method, and then subjected to a particle spheroidization treatment to form spheres. Thereby, the resin powder having the following characteristics (1) to (3) specified in the present invention may be obtained.

(1) The volume average particle size of the resin particles is in the range of 1 to 200 μm.
(2) The value of the ratio (MV/MN) of the volume average particle size MV and the number average particle size MN of the resin particles is 2.5 or more.
(3) The static bulk density is 0.30 g/cm³ or more.

In a particle spheroidization treatment method applicable to the present invention, as a typical method thereof, a means for applying a mechanical impact force may be cited. For example, a method using a mechanical impact type crusher such as a cryptron system manufactured by Kawasaki Heavy Industries, Ltd., or a turbo mill manufactured by Turbo Industries, Ltd. may be mentioned. In addition, like a mechanofusion system manufactured by Hosokawa Micron Corporation and a hybridization system manufactured by Nara Machinery Co., Ltd., examples thereof include a method in which particles are pressed against the inside of a casing by a centrifugal force by a blade rotating at high speed, and a mechanical impact force is applied to the particles by a force such as a compressive force or a frictional force.

As a hot air treatment, Meteorainbow of Nippon Pneumatic Mfg. Co., Ltd. may also be mentioned.

An example of a specific device and conditions of a typical particle spheroidization treatment method is shown below.

### <Particle Spheroidization Treatment by COMPOSI: Particle Design Device>

COMPOSI (registered trademark of Nippon Coke & Engineering Co., Ltd.) has an impeller that rotates at high speed and a fixed collision plate in the container, and it is a device that spheroidizing particles by applying an impact force to the powder while dispersing it with the impeller. Examples thereof include COMPOSI MP5 type, CP15 type, and CP60 type, manufactured by Nippon Coke & Engineering Co., Ltd.

As a condition for spheroidization, for example, the particle size may be reduced by a dispersion treatment within a range of a charging amount of 100 to 10,000 g, a treatment time of 30 to 80 minutes, and a peripheral speed of 40 to 100 m/s.

### <Spheroidization Treatment by Hybridization System (NHS): Particle Design Device>

A hybridization system “NHS” (manufactured by Nara Machinery Co., Ltd.) is a device using a method of spheroidizing amorphous particles in a dry manner by using a force mainly due to the impact force between particles while dispersing the raw materials in a high-speed air flow.

Specific examples thereof include NHS-0 type, NHS-1 type, NHS-2 type, NHS-3 type, NHS-4 type, and NHS-5 type manufactured by Nara Machinery Co., Ltd.

For example, when the NH S-3 type is used, the treatment may be made with the charging amount of 600 to 1,600 g, the treatment time of 1 to 30 minutes, and the peripheral speed in the range of 50 to 100 m/s.

<Spheroidization Treatment with Meteorainbow: Surface Reforming Device for Fine Powder>

Meteorainbow MR Type (manufactured by Nippon Pneumatic Mfg. Co., Ltd.) melts the particles with hot air by dispersing and spraying plastic fine particles into hot air (treatment temperature: about 400° C.). The particle temperature immediately reaches the melting start temperature, and the melted particles are surface modifiers that spheroidize the melt particles by the surface tension of the particles themselves. There is little thermal deterioration of the material due to cooling, and since it is processed in a completely dispersed state, there is no granulation between particles.

Specific examples thereof include MR-2, MR-10, MR-50, and MR-100 manufactured by Nippon Pneumatic Mfg. Co, Ltd.

For example, when the spheroidization treatment is performed using Meteorainbow MR, the treatment may be performed in the range of a charging amount of 0.5 to 5 kg/hour, a hot air volume of 500 to 2000 L/min, and a discharge temperature of 300 to 600° C.

### <<Three-Dimensional Laminated Model>>

The three-dimensional laminated model of the present invention is a three-dimensional laminated model formed by using the resin powder for three-dimensional laminate modeling, and is characterized by being a sintered body or a melt body of the resin powder for three-dimensional laminate modeling.

Further, the three-dimensional laminated model of the present invention is preferably produced by the powder bed fusion method (PBF method) described later using the resin powder for three-dimensional laminated modeling of the present invention.

### [Production Method of Three-Dimensional Laminated Model]

The production method of three-dimensional laminated model of the present invention may be carried out in the same manner as the conventionally known powder bed fusion method except that the resin powder for three-dimensional laminated modeling of the present invention is used.

Specifically, the method for producing a three-dimensional laminated model of the present invention has the following steps.

Step (1): forming a thin layer of the resin powder for three-dimensional laminated modeling;

Step (2): selectively irradiating the preheated thin layer with laser light to form a molded product layer in which crystalline thermoplastic resin particles contained in the three-dimensional laminated modeling resin powder are melt-bonded.

Step (3): repeating the above step (1) of forming the thin layer and the above step (2) of forming the modeling object layer of the above (2) a plurality of times in this order, and laminating the modeling object layer.

By the above step (2), one layer of the modeling object layer constituting the three-dimensional laminated model is formed, and by repeating the steps (1) and (2) in the step (3), the next layer of the three-dimensional laminated model is laminated. Thus, the final three-dimensional laminated model is produced.

In the production method of a three-dimensional laminated model of the present invention, the following step (4) may be performed before the step (2).

The step (4): preheating the formed thin layer of the resin powder for three-dimensional laminated modeling.

### (Step (1) of Forming a Thin Layer Made of a Resin Powder for Three-Dimensional Lamination Modeling)

In step (1), a thin layer made of a resin powder for three-dimensional laminated modeling of the present invention is formed. For example, as shown in the figure to be described later, a resin powder 6 for three-dimensional laminated modeling of the present invention supplied from a powder supply unit 121 is flatly spread on a modeling stage 110 by a recoater 122a. The thin layer may be formed directly on the modeling stage, or may be formed so as to be in contact with the resin powder for three-dimensional laminated modeling already spread or the already formed model layer.

The thickness of the thin layer may be set according to the thickness of the modeling object layer. The thickness of the thin layer may be arbitrarily set according to the accuracy of the three-dimensional laminated model to be manufactured, but is usually in the range of 0.08 to 0.20 mm. By setting the thickness of the thin layer to 0.08 mm or more, it is possible to prevent the crystalline thermoplastic resin particles in the lower layer from melt-bonding by laser irradiation for forming the next layer, and the modeling object layer in the lower layer from melting again. By setting the thickness of the thin layer to 0.20 mm or less, it is possible to conduct the energy of the laser to the lower part of the thin layer, and the crystalline thermoplastic resin particles contained in the resin powder 6 for three-dimensional laminated modeling constituting the thin layer may be sufficiently melt-bonded over the entire thickness direction.

From the above viewpoint, setting the thickness of the thin layer in the range of 0.10 to 0.15 mm is more preferable from the viewpoint of achieving sufficiently melt-bonding the copolymer particles over the entire thickness direction of the thin layer, and making cracks between layers less likely to occur.

### (Step (2) of Forming a Modeling Object Layer Formed by Melt-Bonding Crystalline Thermoplastic Resin Particles)

In step (2), the laser is selectively irradiated to the position where the modeling object layer should be formed among the formed thin layers, and the crystalline thermoplastic resin particles at the irradiated position are melt-bonded. As a result, the adjacent crystalline thermoplastic resin particles are melted together to form a melt-bonded body, which becomes a modeling object layer. At this time, since the crystalline thermoplastic resin particles that have received the energy of the laser are melt-bonded to the already formed layer, adhesion between adjacent layers also occurs.

The wavelength of the laser may be set within a range in which the wavelength corresponding to the energy required for vibration and rotation of the constituent molecules of the crystalline thermoplastic resin particles is absorbed. At this time, it is preferable to make the difference between the wavelength of the laser and the wavelength having the highest absorption rate small. Since the resin may absorb light in various wavelength ranges, it is preferable to use a laser having a wide wavelength band such as a CO₂ laser. For example, the wavelength of the laser is preferably in the range of 8 to 12 μm.

For example, the power at the time of laser output may be set within a range in which the above-mentioned copolymer particles are sufficiently melt-bonded at the scanning speed of the laser described later, and specifically, it may be set in the range of 10 to 100 W. From the viewpoint of lowering the energy of the laser, lowering the manufacturing cost, and simplifying the configuration of the manufacturing equipment, the power at the time of output of the laser is preferably 80 W or less, and more preferably 60 W or less.

The scanning speed of the laser may be set within a range that does not increase the manufacturing cost and does not excessively complicate the device configuration. Specifically, it is preferably in the range of 20,000 mm/sec, more preferably in the range of 1,000 to 18,000 mm/sec, more preferably in the range of 2,000 to 15,000 mm/sec, still more preferably in the range of 4,000 to 15,000 mm/sec, and further more preferably in the range of 5,000 to 15,000 mm/sec.

The beam diameter of the laser can be appropriately set according to the required accuracy of the three-dimensional laminated model to be manufactured.

### (Step (3) of Laminating a Thin Layer of Resin Powder for Three-Dimensional Laminated Modeling to Form a Three-Dimensional Laminated Model)

In step (3), step (1) and step (2) are repeated to stack the modeling object layers formed by step (2). By laminating the modeling object layers, a three-dimensional laminated modeling object having a desired structure is produced.

### (Step (4) of Preheating a Thin Layer of Resin Powder for Three-Dimensional Lamination Modeling)

Step (4) is a step of preheating the thin layer made of the resin powder for three-dimensional laminated modeling formed in step 1 before forming the modeling object layer by step (2). For example, the temperature of the surface of the thin layer (standby temperature) may be heated to 15° C. or lower, preferably 5° C. or lower than the melting point of the crystalline thermoplastic resin particles by using a heater.

### (Other Steps)

From the viewpoint of preventing a decrease in the strength of the three-dimensional laminated model due to oxidation of the copolymer particles during the melt bonding, it is preferable that at least step (2) is performed under reduced pressure or in an inert gas atmosphere. The pressure at the time of depressurization is preferably 1×10⁻² Pa or less, and more preferably 1×10⁻³ Pa or less.

Examples of the inert gas that may be used in the present invention include nitrogen gas and noble gas.

Among these inert gases, nitrogen (N₂) gas, helium (He) gas or argon (Ar) gas is preferable from the viewpoint of easy availability.

From the viewpoint of simplifying the manufacturing process, it is preferable to perform all of steps (1) to (3) (when step (4) is included, all of steps (1) to (4)) under reduced pressure or in an inert gas atmosphere.

### <<Three-Dimensional Modeling Apparatus>>

As a three-dimensional modeling apparatus applicable to the production of the three-dimensional laminated model of the present invention, other than using the resin powder for three-dimensional laminated modeling of the present invention, an apparatus similar to a known apparatus for producing a three-dimensional laminated model by a powder bed fusion method may be applied without limitation.

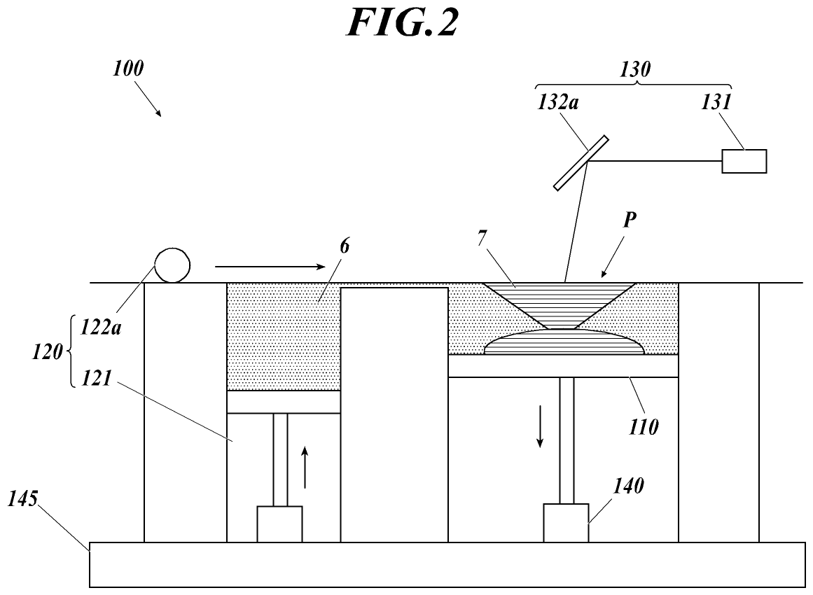

FIG. 2 shows a schematic side view of a three-dimensional modeling apparatus applicable to the present invention.

In FIG. 2, a three-dimensional modeling apparatus 100 is provided with a modeling stage located inside the opening, a thin film forming unit 120 that forms a thin film of a resin powder 6 for three-dimensional laminated modeling containing the crystalline thermoplastic resin particles of the present invention on the modeling stage, a laser irradiation unit 130 for irradiating a thin film with a laser to melt-bond the crystalline thermoplastic resin particles to form a modeling object layer 7, and a stage support for supporting a modeling stage 110 in a variable vertical position, a stage support unit 140 that supports the modeling stage 110 in a variable vertical position, and a base 145 that supports each of the above units.

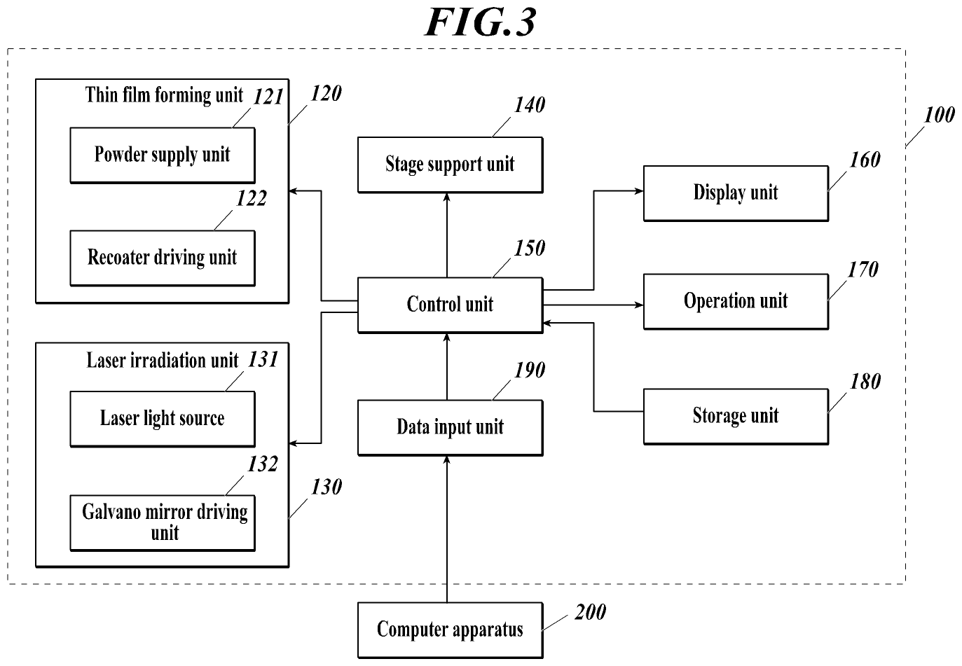

FIG. 3 shows a block diagram of the main part of the control system of the three-dimensional modeling apparatus.

As shown in FIG. 3, a three-dimensional modeling apparatus 100 may include the following: a control unit 150 that controls the thin film forming unit 120, a laser irradiation unit 130, and a stage support unit 140 to repeatedly form and stack the above-mentioned modeling object layers, a display unit 160 for displaying various information, an operation unit 170 including a pointing device for receiving instructions from a user, a storage unit 180 for storing various information including a control program executed by the control unit 150, and various types of three-dimensional modeling data with an external device, further, a data input unit 190 including an interface for transmitting and receiving various information such as three-dimensional modeling data to and from an external device. A computer apparatus 200 for generating data for three-dimensional modeling may be connected to the three-dimensional modeling apparatus 100.

As shown in FIG. 2, on the modeling stage 110, a modeling object layer 7 is formed by forming a thin layer by the thin film forming unit 120 and irradiating the laser by the laser irradiation unit 130, and the modeling object layer 7 is laminated. As a result, the three-dimensional laminated model P is produced.

The thin film forming unit 120 may have the following configuration: an opening whose edge is substantially in the same plane as the edge of the opening where the modeling stage 110 moves up and down; a powder supply unit 121 provided with a powder material storage unit extending vertically downward from the opening; a supply piston that moves up and down in the opening disposed at the bottom of the powder material storage unit; and a recoater 122a that flatly spreads the supplied resin powder 6 for three-dimensional laminated modeling on the modeling stage 110 to form a thin layer of powder material.

The powder supply unit 121 may be provided with a powder material storage unit and a nozzle provided vertically above the modeling stage 110, and it may discharge the resin powder 6 for three-dimensional laminated modeling on the same plane in the horizontal direction as the modeling stage.

The laser irradiation unit 130 includes a laser light source 131 and a galvano mirror 132a. The laser irradiation unit 130 may include a lens (not shown) for adjusting the focal length of the laser to the surface of the thin layer. The laser light source 131 may be any light source that emits a laser having the above wavelength with the above output. Examples of the laser light source 131 include a YAG laser light source, a fiber laser light source and a CO₂ laser light source. The galvano mirror 132a may be composed of an X mirror that reflects the laser emitted from the laser light source 131 and scans the laser in the X direction and a Y mirror that scans in the Y direction.

The stage support unit 140 variably supports the modeling stage 110 in its vertical position. That is, the modeling stage 110 is configured to be precisely movable in the vertical direction by the stage support unit 140. Various configurations may be adopted for the stage support unit 140. The stage support unit 140 is composed of, for example, a holding member that holds the modeling stage 110, a guide member that guides the holding member in the vertical direction, a ball screw that engages with a screw hole provided in the guide member.

The control unit 150 shown in FIG. 3 controls the operation of the entire three-dimensional modeling apparatus 100 during the modeling operation of the three-dimensional laminated modeling.

Further, the control unit 150 includes a hardware processor such as a central processing unit. For example, the data input unit 190 may be configured to convert the three-dimensional modeling data acquired from the computer apparatus 200 into a plurality of slice data sliced in the stacking direction of the modeling object layer. The slice data is modeling data of each modeling object layer 7 for modeling the three-dimensional laminated model P. The thickness of the slice data, that is, the thickness of the modeling object layer 7, corresponds to the distance (stacking pitch) corresponding to the thickness of one layer of the modeling object layer.

The display unit 160 may be, for example, a liquid crystal display or a monitor.

The operation unit 170 may include a pointing device such as a keyboard or a mouse, and may include various operation keys such as a numeric keypad, an execution key, and a start key.

The storage unit 180 may include various storage media such as ROM (read-only memory), RAM (random access memory), magnetic disk, HDD (hard disk drive), and SSD (solid state drive).

The three-dimensional modeling apparatus 100 may be provided with a decompression unit (not shown) such as a decompression pump that decompresses the inside of the apparatus under the control of the control unit 150. Alternatively, it may include an inert gas supply unit (not shown) that supplies the inert gas into the apparatus under the control of the control unit 150. Further, the three-dimensional modeling apparatus 100 may include a heater (not shown) that heats the inside of the apparatus, particularly the upper surface of the thin layer made of the resin powder 6 for three-dimensional laminated modeling, under the control of the control unit 150.

### Example of Three-Dimensional Modeling Using the Three-Dimensional Modeling Apparatus 100

The control unit 150 shown in FIG. 3 converts the three-dimensional modeling data acquired from the computer apparatus 200 by the data input unit 190 into a plurality of slice data sliced in the stacking direction of the modeling object layer 7. After that, the control unit 150 controls the following operations in the three-dimensional modeling apparatus 100.

The powder supply unit 121 drives the motor and the drive mechanism (both not shown) according to the supply information output from the control unit 150, moves the supply piston upward in the vertical direction (in the direction of the arrow in the figure), and extrudes the resin powder for three-dimensional laminated modeling on the same plane in the horizontal direction as the modeling stage.

After that, a recoater driving unit 122 moves a recoater 122a in the horizontal direction (in the direction of the arrow in the figure) according to the thin film forming information output from the control unit 150, and carries the resin powder 6 for three-dimensional laminated modeling to the modeling stage 110. In addition, the powder material is pressed so that the thickness of the thin layer becomes the thickness of one layer of the modeling object layer 7.

After that, the laser irradiation unit 130 emits a laser from the laser light source 131 according to the laser irradiation information output from the control unit 150, conforming to the region constituting the three-dimensional laminated model in each slice data on the thin film. The galvano mirror 132a is driven by the galvano mirror driving unit 132 to scan the laser. By irradiating the laser, the crystalline thermoplastic resin particles contained in the resin powder 6 for three-dimensional laminated modeling are melt-bonded to form the modeling object layer 7.

After that, the stage support unit 140 drives the motor and the drive mechanism (both not shown) according to the position control information output from the control unit 150. It moves the modeling stage 110 downward by the stacking pitch in the vertical direction (in the direction of the arrow in FIG. 2).

The display unit 160 receives the control of the control unit 150 as necessary, and displays various information and messages to be recognized by the user. The operation unit 170 receives various input operations by the user and outputs an operation signal corresponding to the input operation to the control unit 150. For example, the virtual three-dimensional laminated model P to be formed is displayed on the display unit 160 to confirm whether or not the desired shape is formed, and if the desired shape is not formed, a modification may be made from the operation unit 170.

The control unit 150 stores data in the storage unit 180 or retrieves data from the storage unit 180, if necessary.

By repeating these operations, the modeling object layers are laminated to produce a three-dimensional laminated model.

### Examples

Hereinafter, the present invention will be specifically described with reference to examples, but the present invention is not limited thereto. In the following examples, the operation was performed at room temperature (25° C.) unless otherwise specified. Unless otherwise specified, “%” and “part” mean “mass %” and “part by mass”, respectively.

### <<Preparation of Resin Powder>>

### [Preparation of Resin Powder 1]

The resin powder 1 for three-dimensional laminated modeling was prepared according to the following method.

### (Mechanical Crushing Treatment of Resin Material)

Polypropylene resin (Noblen FLX80E4 manufactured by Sumitomo Chemical Co., Ltd.) was used as the crystalline thermoplastic resin, and the polypropylene resin was cooled to about −150° C. with liquid nitrogen. Polypropylene resin particles were prepared by crushing with a crusher (Linlex mill) until the volume average particle diameter MV became 80 μm.

### (Particle Spheroidization Treatment)

The polypropylene resin particles prepared by crushing by the above method were subjected to particle spheroidization treatment according to the following method to prepare polypropylene resin powder 1.

### <COMPOSI Method>

The crushed polypropylene resin particles were spheroidized using COMPOSI CP15 type manufactured by Nippon Coke & Engineering Co., Ltd.

The conditions for spheroidization were as follows: the amount charged was 1000 g, the processing time was 45 minutes, and the peripheral speed was 60 m/s. Thus, a resin powder 1 was obtained.

### (Measurement of Each Particle Size Characteristic and Particle Size Distribution Characteristic Value in Resin Powder 1)

The volume average particle size MV and the number average particle size MN of the resin powder 1 were measured by using a particle size distribution measuring device (Microtrac MT3300EXII manufactured by MicrotracBEL Co., Ltd.). The particle refractive index of the resin powder 1 was used, no solvent was used, and the measurement was performed by a dry (air) method. The refractive index of the particles was set to 1.5.

As a measurement procedure, 0.1 g of resin powder 1 was weighed, then, 0.2 g of surfactant (EMAL E-27C, manufactured by Kao Corporation) and 30 mL of water were added thereto, and ultrasonic dispersion was performed for 10 minutes to prepare a sample. As a result of measuring the volume average particle size MV and the number average particle size MN using the above particle size distribution measuring apparatus, the volume average particle size MV was 80 μm, the number average particle size MN was 30 μm, and the MV/MN was 2.7. The minimum particle size in volume particle was 18 μm, and the maximum particle size was 160 μm.

Further, in the resin powder 1, the small-sized resin particles having an average particle size in the range of 0.15 to 0.41 times the number average particle size MN existed in an amount of the same or more with respect to the particle number of the particles having the number average particle size MN. In Table I, “AA” was indicated as the particle ratio characteristic (*2).

### (Measurement of Static Bulk Density)

A commercially available bulk density measuring apparatus was used, and a cubic cup was used as a measuring container. The minimum amount was set to 25 cm³, and the resin powder was allowed to flow down through the measuring apparatus until the excess powder overflowed into the cup that was the receiver. Smoothly moved the blade of the spatula that was in contact with the top surface of the cup vertically, and kept the spatula vertical to prevent consolidation and powder overflow from the cup, and carefully scraped off excess resin powder from the top surface of the cup. Then, all the samples were removed from the side surface of the cup, and the mass (m) of the powder was measured to a unit of 0.1%.

Then, according to the formula: m/V0 (V0 is the volume of the cup), the static bulk density (g/cm³) was measured for three different batches of samples, and the average value was calculated. As a result, it was 0.370 (g/cm³).

### [Preparation of Resin Powder 2]

In the preparation of the resin powder 1, the resin powder 2 was prepared in the same manner except that the particle spheroidization treatment method was changed to the spheroidization treatment method by the hybridization system (NHS).

### (Spheroidization Treatment by Hybridization System (NHS))

A hybridization system NHS-3 type (manufactured by Nara Machinery Co., Ltd.) was used with conditions of: a charging amount of 800 g, a processing time of 5 minutes, and a peripheral speed of 90 m/s.

### (Measurement of Each Particle Size Characteristic and Particle Size Distribution Characteristic Value in Resin Powder 2)

As a result of measuring the volume average particle size MV and the number average particle size MN of the resin powder 2 by the same method as above, the volume average particle size MV was 80 μm, the number average particle size MN was 30 μm, and MV/MN was 2.7. The minimum particle size in volume particle was 11 μm, and the maximum particle size was 160 μm.

Further, in the resin powder 2, the small-sized resin particles having an average particle size in the range of 0.15 to 0.41 times the number average particle size MN exited in an amount of the same or more with respect to the particle number of the particles having the number average particle size MN. In Table I, “AA” was indicated as the particle ratio characteristic (*2).

The static bulk density measured by the same method as above was 0.382 g/cm³.

### [Preparation of Resin Powder 3]

In the preparation of the resin powder 1, the resin powder 3 was prepared in the same manner except that the particle spheroidization treatment method was changed to the spheroidization treatment method using Meteorainbow.

### (Spheroidization Treatment by Meteorainbow)

Using Meteorainbow MR-10 manufactured by Nippon Pneumatic Mfg. Co., Ltd., the treatment was done with the conditions of: a charging amount of 1 kg/hour, a hot air volume of 1200 L/min, and a discharge temperature of 550° C.

### (Measurement of Each Particle Size Characteristic and Particle Size Distribution Characteristic Value in Resin Powder 3)

As a result of measuring the volume average particle size MV and the number average particle size MN of the resin powder 3 by the same method as above, the volume average particle size MV was 80 μm, the number average particle size MN was 27 μm, and MV/MN was 2.9. The minimum particle size in volume particle was 25 μm and the maximum particle size was 160 μm.

Further, in the resin powder 3, the small-sized resin particles having an average particle size in the range of 0.15 to 0.41 times the number average particle size MN exited in an amount of the same or more with respect to the particle number of the particles having the number average particle size MN. In Table I, “AA” was indicated as the particle ratio characteristic (*2).

The static bulk density measured by the same method as above was 0.400 g/cm³.

### [Preparation of Resin Powder 4]

In the preparation of the resin powder 1, the resin powder 4 was prepared in the same manner except that the mechanical crushing treatment and the particle spheroidization treatment conditions were appropriately adjusted so that the minimum particle size in the volume particle size was 18 μm and the maximum particle size was 190 μm.

Further, in the resin powder 4, the small-sized resin particles having an average particle size in the range of 0.15 to 0.41 times the number average particle size MN exited in an amount of the same or more with respect to the particle number of the particles having the number average particle size MN. In Table I, “AA” was indicated as the particle ratio characteristic (*2).

### [Preparation of Resin Powder 5]

In the preparation of the resin powder 1, the resin powder 5 was prepared in the same manner except for the change of adding silica particles (Aerosil R972, average particle size: 16 nm, manufactured by Nippon Aerosil Co., Ltd.) as inorganic oxides to polypropylene resin (Noblen FLX80E4, manufactured by Sumitomo Chemical Co., Ltd.) in an amount of 0.1 mass %.

As a result of measuring the volume average particle size MV and the number average particle size MN of the resin powder 5 by the same method as above, the volume average particle size MV was 80 μm, the number average particle size MN was 30 μm, and MV/MN was 2.7. The minimum particle size in volume particle was 18 μm and the maximum particle size was 160 μm.

Further, in the resin powder 5, the small-sized resin particles having an average particle size in the range of 0.15 to 0.41 times the number average particle size MN exited in an amount of the same or more with respect to the particle number of the particles having the number average particle size MN. In Table I, “AA” was indicated as the particle ratio characteristic (*2).

The static bulk density measured by the same method as above was 0.378 g/cm³.

### [Preparation of Resin Powder 6]

In the preparation of the resin powder 1, the resin powder 6 was prepared in the same manner except for the change of adding silica particles (Aerosil R972, average particle size: 16 nm, manufactured by Nippon Aerosil Co., Ltd.) as inorganic oxides to polypropylene resin (Noblen FLX80E4, manufactured by Sumitomo Chemical Co., Ltd.) in an amount of 0.3 mass %.

As a result of measuring the volume average particle size MV and the number average particle size MN of the resin powder 6 by the same method as above, the volume average particle size MV was 80 μm, the number average particle size MN was 30 μm, and MV/MN was 2.7. The minimum particle size in volume particle was 18 μm and the maximum particle size was 160 μm.

Further, in the resin powder 6, the small-sized resin particles having an average particle size in the range of 0.15 to 0.41 times the number average particle size MN exited in an amount of the same or more with respect to the particle number of the particles having the number average particle size MN. In Table I, “AA” was indicated as the particle ratio characteristic (*2).

The static bulk density measured by the same method as above was 0.382 g/cm³.

### [Preparation of Resin Powder 7]

In the preparation of the resin powder 1, the resin powder 7 was prepared in the same manner except that polybutylene terephthalate (Novaduran 5010R3 manufactured by Mitsubishi Chemical Corporation) was used instead of the polypropylene resin as the crystalline thermoplastic resin.

As a result of measuring the volume average particle size MV and the number average particle size MN of the resin powder 7 by the same method as above, the volume average particle size MV was 70 μm, the number average particle size MN was 25 μm, and MV/MN was 2.8. The minimum particle size in volume particle was 18 μm and the maximum particle size was 140 μm.

Further, in the resin powder 7, the small-sized resin particles having an average particle size in the range of 0.15 to 0.41 times the number average particle size MN exited in an amount of the same or more with respect to the particle number of the particles having the number average particle size MN. In Table I, “AA” was indicated as the particle ratio characteristic (*2).

The static bulk density measured by the same method as above was 0.365 g/cm³.

### [Preparation of Resin Powder 8]

In the preparation of the resin powder 1, the resin powder 8 was prepared in the same manner except that polyamide was used instead of the polypropylene resin as the crystalline thermoplastic resin.

As a result of measuring the volume average particle size MV and the number average particle size MN of the resin powder 8 by the same method as above, the volume average particle size MV was 80 μm, the number average particle size MN was 30 μm, and MV/MN was 2.7. The minimum particle size in volume particle was 18 μm and the maximum particle size was 160 μm.

Further, in the resin powder 8, the small-sized resin particles having an average particle size in the range of 0.15 to 0.41 times the number average particle size MN exited in an amount of the same or more with respect to the particle number of the particles having the number average particle size MN. In Table I, “AA” was indicated as the particle ratio characteristic (*2).

The static bulk density measured by the same method as above was 0.377 g/cm³.

### [Preparation of Resin Powder 9]

In the preparation of the resin powder 1, the resin powder 9 was prepared in the same manner except that polyetherketone was used instead of the polypropylene resin as the crystalline thermoplastic resin.

As a result of measuring the volume average particle size MV and the number average particle size MN of the resin powder 9 by the same method as above, the volume average particle size MV was 80 μm, the number average particle size MN was 30 μm, and MV/MN was 2.7. The minimum particle size in volume particle was 18 μm and the maximum particle size was 160 μm.

Further, in the resin powder 9, the small-sized resin particles having an average particle size in the range of 0.15 to 0.41 times the number average particle size MN exited in an amount of the same or more with respect to the particle number of the particles having the number average particle size MN. In Table I, “AA” was indicated as the particle ratio characteristic (*2).

The static bulk density measured by the same method as above was 0.376 g/cm³.

### [Preparation of Resin Powder 10]

In the preparation of the resin powder 1, polyethylene was used as the crystalline thermoplastic resin instead of the polypropylene resin. Further, the resin was similarly adjusted except that the mechanical crushing treatment and the particle spheroidization treatment conditions were appropriately adjusted so that the volume average particle size MV was 80 μm, the number average particle size MN was 35 μm, and the MV/MN was 2.3. Thus, the resin powder 10 was prepared.

Further, in the resin powder 10, the small-sized resin particles having an average particle size in the range of 0.15 to 0.41 times the number average particle size MN exited in an amount of the same or more with respect to the particle number of the particles having the number average particle size MN. In Table I, “AA” was indicated as the particle ratio characteristic (*2).

### [Preparation of Resin Powder 11]

In the preparation of the resin powder 1, the resin powder 11 was prepared in the same manner except that the particle spheroidization treatment was not performed.

As a result of measuring the volume average particle size MV and the number average particle size MN of the resin powder 11 by the same method as above, the volume average particle size MV was 80 μm, the number average particle size MN was 30 μm, and MV/MN was 2.7. The minimum particle size in volume particle was 6 μm and the maximum particle size was 160 μm.

Further, in the resin powder 11, the small-sized resin particles having an average particle size in the range of 0.15 to 0.41 times the number average particle size MN exited in an amount of the same or more with respect to the particle number of the particles having the number average particle size MN. In Table I, “AA” was indicated as the particle ratio characteristic (*2).

The static bulk density measured by the same method as above was 0.280 g/cm³.

### [Preparation of Resin Powder 12]

In the preparation of the resin powder 1, the resin powder 12 was prepared in the same manner except that the particle spheroidization treatment method was changed to the spheroidization treatment method by the melt precipitation method.

### (Spheroidization by Melt Precipitation Method)

20 g of polypropylene, 180 g of decane, and 0.2 g of silica particles (Aerosil R972, average particle size: 16 nm, manufactured by Nippon Aerosil Co., Ltd.) were placed in a 500 mL container and raised to 170° C. with stirring. Then, the mixture was allowed to stand by with stirring for 1 hour and air-cooled to room temperature. The obtained particles were washed with ethanol and dried to prepare a resin powder 12.

As a result of measuring the volume average particle size MV and the number average particle size MN of the resin powder 12 by the same method as above, the volume average particle size MV was 50 μm, the number average particle size MN was 30 μm, and MV/MN was 1.7. The minimum particle size in volume particle was 5 μm and the maximum particle size was 90 μm.

Further, in the resin powder 12, the small-sized resin particles having an average particle size in the range of 0.15 to 0.41 times the number average particle size MN exited in an amount of the same or more with respect to the particle number of the particles having the number average particle size MN. In Table I, “AA” was indicated as the particle ratio characteristic (*2).

The static bulk density measured by the same method as above was 0.450 g/cm³.

### [Preparation of Resin Powder 13]

In the preparation of the resin powder 1, the resin powder 13 was prepared in the same manner except that the particle spheroidization treatment method was changed to the spheroidization treatment method by the melt precipitation method.

### (Spheroidization by Melt Precipitation Method)

20 g of polypropylene, 180 g of decane, and 0.4 g of silica particles (Aerosil R972, average particle size: 16 nm, manufactured by Nippon Aerosil Co., Ltd.) were placed in a 500 mL container and raised to 170° C. with stirring. Then, the mixture was allowed to stand by with stirring for 1 hour and air-cooled to room temperature. The obtained particles were washed with ethanol and dried to prepare a resin powder 13.

As a result of measuring the volume average particle size MV and the number average particle size MN of the resin powder 13 by the same method as above, the volume average particle size MV was 50 μm, the number average particle size MN was 45 μm, and MV/MN was 1.1. The minimum particle size in volume particle was 5 μm and the maximum particle size was 90 μm.

Further, in the resin powder 13, the small-sized resin particles having an average particle size in the range of 0.15 to 0.41 times the number average particle size MN exited in an amount of less than the same number with respect to the particle number of the particles having the number average particle size MN. In Table I, “BB” was indicated as the particle ratio characteristic (*2).

The static bulk density measured by the same method as above was 0.462 g/cm³.

### [Preparation of Resin Powder 14]

In the preparation of the resin powder 1, the resin powder 14 was prepared in the same manner except that ABS (acrylonitrile-butadiene-styrene GR-0500, manufactured by DENKA Co., Ltd.), which is an amorphous resin, was used instead of the polypropylene resin, which is a crystalline thermoplastic resin.

As a result of measuring the volume average particle size MV and the number average particle size MN of the resin powder 14 by the same method as above, the volume average particle size MV was 80 μm, the number average particle size MN was 30 μm, and MV/MN was 2.7. The minimum particle size in volume particle was 18 μm and the maximum particle size was 160 μm.

Further, in the resin powder 14, the small-sized resin particles having an average particle size in the range of 0.15 to 0.41 times the number average particle size MN exited in an amount of the same or more with respect to the particle number of the particles having the number average particle size MN. In Table I, “AA” was indicated as the particle ratio characteristic (*2).

The static bulk density measured by the same method as above was 0.360 g/cm³.

### [Preparation of Resin Powder 15]

In the preparation of the resin powder 1, the resin powder 15 was prepared in the same manner except that polystyrene, which is an amorphous resin, was used instead of the polypropylene resin, which is a crystalline thermoplastic resin.

As a result of measuring the volume average particle size MV and the number average particle size MN of the resin powder 15 by the same method as above, the volume average particle size MV was 80 μm, the number average particle size MN was 30 μm, and MV/MN was 2.7. The minimum particle size in volume particle was 18 μm and the maximum particle size was 160 μm.

Further, in the resin powder 15, the small-sized resin particles having an average particle size in the range of 0.15 to 0.41 times the number average particle size MN exited in an amount of the same or more with respect to the particle number of the particles having the number average particle size MN. In Table I, “AA” was indicated as the particle ratio characteristic (*2).

The static bulk density measured by the same method as above was 0.360 g/cm³.

### <<Production of Three-Dimensional Laminated Model>>

Using the resin powders 1 to 15 prepared above, three-dimensional laminated models 1 to 15 were produced according to the following method.

Using a three-dimensional modeling apparatus sPro140 (manufactured by 3D Systems Corporation), each of the above-mentioned particulate resin powders prepared above was spread on a modeling stage at a predetermined recoating speed (100 mm/s) to form a thin layer having a thickness of 0.1 mm.

This thin layer was irradiated with a laser light under the following conditions from a CO₂ laser equipped with a galvanometer scanner for YAG wavelength to a range of 15 mm in length×20 mm in width under the emission conditions and scanning conditions described below, and the modeling object layer was produced. Then, the resin powder was further spread on the modeling object layer, irradiated with a laser light, and the modeling object layer was laminated. These steps were repeated to produce a three-dimensional laminated model.

### (Laser Light Emission Conditions)

Laser output: 12 W

Laser light wavelength: 10.6 μm

Beam diameter: 170 μm on the thin layer surface

### (Laser Light Scanning Conditions)

Scanning speed: 2,000 mm/sec

Number of lines: 1 line

### <<Evaluation of Three-Dimensional Laminated Model>>

The tensile elastic modulus (MPa) of the three-dimensional laminated model produced above was measured according to the following method.

The tensile elastic modulus was measured with the TENSILON universal material tester RTC-1250 (A & D Co., Ltd.) for the obtained three-dimensional laminated model. The measurement conditions were set as follows. The tensile modulus was determined by linear regression between strains of 0.05 to 0.25%.

Test piece for tensile test: Shape conforming to JIS K7161

Tensile speed: 1 mm/s

Distance between chucks: 115 mm

Distance between gauge points: 100 mm

The results obtained as described above are shown in Table I.

TABLE I

| Three- | | | | | | | |
|---|---|---|---|---|---|---|---|
| dimensional | Resin | | Inorganic oxide | | Volume average | Number average | |
| laminated | powder | | | Content | particle size MV | particle size MN | |
| model No. | No. | Type of resin | Type | (%) | (μm) | (μm) | MV/MN |
| 1 | 1 | Polypropylene | — | — | 80 | 30 | 2.7 |
| 2 | 2 | Polypropylene | — | — | 80 | 30 | 2.7 |
| 3 | 3 | Polypropylene | — | — | 80 | 27 | 2.9 |
| 4 | 4 | Polypropylene | — | — | 80 | 30 | 2.7 |
| 5 | 5 | Polypropylene | SiO₂ | 0.1 | 80 | 30 | 2.7 |
| 6 | 6 | Polypropylene | SiO₂ | 0.3 | 80 | 30 | 2.7 |
| 7 | 7 | *1 | — | — | 70 | 25 | 2.8 |
| 8 | 8 | Polyamide | — | — | 80 | 30 | 2.7 |
| 9 | 9 | Polyetherketone | — | — | 80 | 30 | 2.7 |
| 10 | 10 | Polyethylene | — | — | 80 | 35 | 2.3 |
| 11 | 11 | Polypropylene | — | — | 80 | 30 | 2.7 |
| 12 | 12 | Polypropylene | SiO₂ | 1.0 | 50 | 30 | 1.7 |
| 13 | 13 | Polypropylene | SiO₂ | 2.0 | 50 | 45 | 1.1 |
| 14 | 14 | ABS | — | — | 80 | 30 | 2.7 |
| 15 | 15 | Polystyrene | — | — | 80 | 30 | 2.7 |

| | Particle size range in | | | | | | |
|---|---|---|---|---|---|---|---|
| | particle-volume | | | | | | |
| Three- | Minimum | Maximum | | | Static | Tensile | |
| dimensional | particle | particle | | Spheroidization | bulk | elastic | |
| laminated | size | size | | treatment | density | modulus | |
| model No. | (μm) | (μm) | *2 | (used device name) | (g/cm³) | (MPa) | Remarks |
| 1 | 18 | 160 | AA | COMPOSI | 0.370 | 1420 | Present |
| | | | | | | | invention |
| 2 | 11 | 160 | AA | Hybridization | 0.382 | 1510 | Present |
| | | | | | | | invention |
| 3 | 25 | 160 | AA | Meteorainbow | 0.400 | 1390 | Present |
| | | | | | | | invention |
| 4 | 18 | 190 | AA | COMPOSI | 0.365 | 1430 | Present |
| | | | | | | | invention |
| 5 | 18 | 160 | AA | COMPOSI | 0.378 | 1400 | Present |
| | | | | | | | invention |
| 6 | 18 | 160 | AA | COMPOSI | 0.382 | 1380 | Present |
| | | | | | | | invention |
| 7 | 18 | 140 | AA | COMPOSI | 0.365 | 2500 | Present |
| | | | | | | | invention |
| 8 | 18 | 160 | AA | COMPOSI | 0.377 | 1850 | Present |
| | | | | | | | invention |
| 9 | 18 | 160 | AA | COMPOSI | 0.376 | 3200 | Present |
| | | | | | | | invention |
| 10 | 18 | 160 | AA | COMPOSI | 0.350 | 1005 | Comparative |
| | | | | | | | Example |
| 11 | 6 | 160 | AA | None | 0.280 | 1000 | Comparative |
| | | | | | | | Example |
| 12 | 5 | 90 | BB | Melt precipitation | 0.450 | 800 | Comparative |
| | | | | method | | | Example |
| 13 | 5 | 90 | BB | Melt precipitation | 0.462 | 600 | Comparative |
| | | | | method | | | Example |
| 14 | 18 | 160 | AA | COMPOSI | 0.360 | *3 | Comparative |
| | | | | | | | Example |
| 15 | 18 | 160 | AA | COMPOSI | 0.360 | *3 | Comparative |
| | | | | | | | Example |

*1: Polybutylene terephthalate
*2: The particle ratio characteristic of the particle having an average particle size in the range of 0.15 to 0.41 times the number average particle size
*3: Cannot be made a model

the value of the ratio (MV/MN) of the volume average particle size MV of the resin particles of 2.5 or more, and static bulk density of 0.30 g/cm³ or more, it was confirmed that the three-dimensional laminated model produced by using the resin powder of the present invention had an excellent tensile elastic modulus as compared with the comparative example.

With the resin powders 14 and 15 using the amorphous thermoplastic resin as the resin, it was not possible to produce a three-dimensional laminated model by the powder bed fusion method.

### INDUSTRIAL APPLICABILITY

The resin powder for three-dimensional laminated modeling of the present invention is a resin powder in which spherical resin particles having different particle sizes are arranged at a high packing density and the tensile strength of the produced three-dimensional laminated model is good. It is suitably used for producing a three-dimensional laminated model by a powder bed fusion method.

### DESCRIPTION OF SYMBOLS

1, P: Three-dimensional laminated model
2: Resin particles (large particle size)
3: Void portion
4: Resin particles (medium particle size)
5: Small-sized resin particles (small particle size)
6: Resin powder for three-dimensional laminated modeling
7: Modeling object layer (single layer)
100: Three-dimensional modeling apparatus
110: Modeling stage
120: Thin film forming unit
121: Powder supply unit
122: Recoater driving unit
122a: Recoater
130: Laser irradiation unit
131: Laser light source
132: Galvano mirror driving unit
132a: Galvano mirror
140: Stage support unit
145: Base
150: Control unit
160: Display unit
170: Operation unit
180: Storage unit
190: Data input unit
200: Computer apparatus

1. A resin powder for three-dimensional laminated modeling comprising an aggregate of resin particles, wherein a volume average particle size MV of the resin particles is in the range of 1 to 200 μm; a value of a ratio (MV/MN) of the volume average particle size MV and a number average particle size MN of the resin particles is 2.5 or more; a static bulk density is 0.30 g/cm³ or more; and the resin particles contain a crystalline thermoplastic resin.

2. The resin powder for three-dimensional laminated modeling according to claim 1, containing small-sized resin particles having an average particle size in the range of 0.15 to 0.41 times the number average particle size MN of the resin particles in an amount of the same or more with respect to a particle number of the resin particles having the number average particle size MN.

3. The resin powder for three-dimensional laminated modeling according to claim 1, wherein inorganic oxide is present on a surface of the resin particles in the range of 0.01 to 0.3 mass % with respect to the resin particles.

4. A method for producing the resin powder for three-dimensional laminated modeling according to claim 1, comprising the steps of:
crushing a resin into resin particles by a mechanical crushing method; and
subjecting the formed resin particles to a particle spheroidization treatment to form spheres.

5. A three-dimensional laminated model formed of a sintered body or a melt body of the resin powder for three-dimensional laminated modeling according to claim 1.

6. A method for producing a three-dimensional laminated model using a resin powder for three-dimensional laminated modeling, comprising the step of:
producing a three-dimensional laminated model by a powder bed fusion method using the resin powder for three-dimensional laminated modeling according to claim 1.

7. The method for producing a three-dimensional laminated model according to claim 6, comprising the steps of:
(1) forming a thin layer of the resin powder for three-dimensional laminated modeling; and
(2) selectively irradiating the formed thin layer with laser light to form a modeling object layer in which the resin particles contained in the resin powder for a three-dimensional laminated modeling are sintered or melt-bonded,
(3) laminating the modeling object layer by repeating the step (1) of forming the thin layer and the step (2) of forming the modeling object layer a plurality of times in this order.
